(19) United States
(12) Patent Application Publication
(10) Pub. No.: US 2008/0208797 A1
(43) Pub. Date: Aug. 28, 2008

(54) AUTOMATED RECORD ATTRIBUTE VALUE MERGING FROM MULTIPLE DIRECTORY SERVERS

(75) Inventors: KENNETH A. WITZKE, Sunnyvale, CA (US); David O'Rourke, San Jose, CA (US)

Correspondence Address: WONG, CABELLO, LUTSCH, RUTHERFORD & BRUCCULERI LLP, 20333 SH 249, SUITE 600, HOUSTON, TX, 77070, US

(73) Assignee: APPLE INC., Cupertino, CA (US)

(21) Appl. No.: 12/021,863

(22) Filed: Jan. 29, 2008

Related U.S. Application Data
(60) Provisional application No. 60/887,280, filed on Jan. 30, 2007.

(51) Int. Cl. G06F 17/30

(52) U.S. Cl. 707/2; 707/E17.01

(57) ABSTRACT

Merging records from a first directory server and a second directory server to augment data from the first server with data from the second server. The records of the second server could contain only data augmenting the data from the record of the first server, or could contain duplicative data in addition to augmenting data, in which case only the augmenting data is merged with the data of the first server.

### CROSS REFERENCE TO RELATED APPLICATIONS

This application claims priority to Provisional U.S. Patent Application Ser. No. 60/887,280, filed Jan. 30, 2007 which is hereby incorporated by reference in its entirety.

### FIELD OF THE INVENTION

The invention relates to multiple directory server integration. In particular, the invention relates to automated record attribute value merging from multiple directory servers.

### BACKGROUND

Many modern companies and institutions currently use directory servers to store information and settings relating to an organization in a central, organized, accessible database. Software applications called directory services allow administrators to assign policies, deploy programs, and apply critical updates on an organization-wide scale using directory servers.

It is desirable to store information on separate directory servers according to the scope of the information and its characteristics. For example, all of the information for one aspect of an organization's operations (e.g., personnel information, managed computer login information, etc.) or for a designated work group (e.g., accounting, design group, etc.) within the organization may be stored on a separate directory server. This information is typically stored as records with attributes. An attribute may have a type and a value. For example, one attribute type may be “user name,” while the attribute value associated with the attribute type “user name” is “John Smith.” Separate records containing various types of information concerning the same user often include a common record identifier such as a user name or user ID.

It is also desirable that accessing the information stored on separate directory servers is seamless. One current solution is to duplicate attribute values for records in multiple directory servers with the same record identifier. However, this approach leads to synchronization concerns, such as the frequency of synchronization being sufficient, and which version of corresponding records to update.

Another solution is to merge the records. In this approach, it is desirable that attributes of records on different servers with the same identifier, such as a user name or computer ID number, can easily be merged. Typically, however, much of this information is stored as records on directory servers maintained with different specific service intents. Each directory server will usually have its fixed schema for a variety of reasons, such as security, ease of maintenance, and so on. The difference in schema between servers prevents attributes of records with the same identifier on these different servers from being easily merged, so that merging is also not a suitable solution in many instances.

### SUMMARY

Disclosed herein are systems, methods, and computer program products for merging records from a first directory server and a second directory server to augment data from the first server with data from the second server. The records of the second server could contain only augmenting data that augments the data from the record of the first server, or could contain duplicative data in addition to augmenting data, in which case only the augmenting data is merged with the data of the first server. A unique record of the second server may be identified for merging with a record of the first server by a globally unique identifier common only to both records.

### BRIEF DESCRIPTION OF THE DRAWINGS

FIG. 1 shows an exemplary directory system.

FIGS. 2A-B set forth block diagrams of exemplary computers.

FIG. 3 is a data flow diagram illustrating records from a directory server and an augmentation server being merged for the use of a workstation.

FIG. 4 is a flow chart illustrating a method for constructing a local record composed of data from directory server records and augmenting data from augmentation records.

### DETAILED DESCRIPTION

Disclosed herein are systems, methods, and computer program products for merging records from a first directory server and a second directory server to augment data from the first server with data from the second server. In this model, the records of the second directory server, or augmentation server, contain data augmenting the records of the first directory server. Only this augmentation data is merged with the first directory server. Specific design details have been provided for illustration but should not be considered limiting. Readers of skill in the art will recognize that many variations of system architecture and directory service schemas may be implemented consistent with the scope of the invention as described by the appended claims.

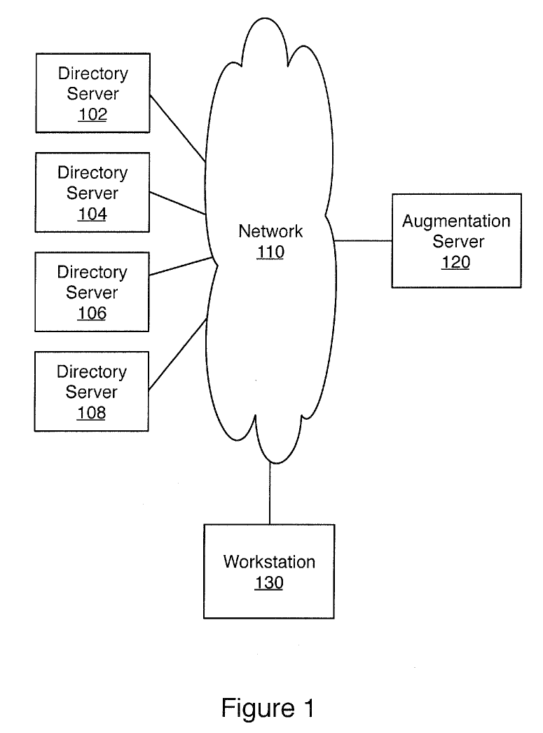

FIG. 1 shows an exemplary directory system. The directory system includes multiple directory servers 102, 104, 106, 108 storing information and settings relating to an organization as user account records using directory services, such as Microsoft's Active Directory and the open source implementation OpenLDAP. The directory system also includes an augmentation server 120 storing only specific managed computer login information such as, for example, disk quota and login time limits, as record attributes. Workstation 130 accesses information from the directory servers 102, 104, 106, 108 and the augmentation server 120, to which it is connected through network 110. Although a workstation is disclosed, any computing device enabled to access the directory servers and the augmentation server may also be used in the present system. Network 110 may be a LAN, WAN, wireless network, or any other computer networking implementation.

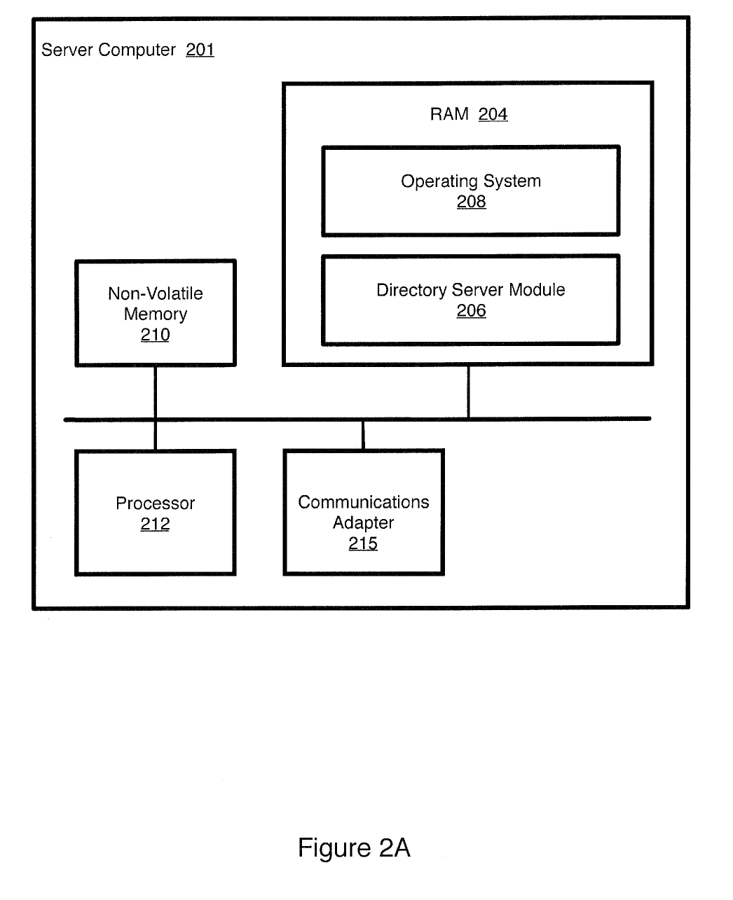

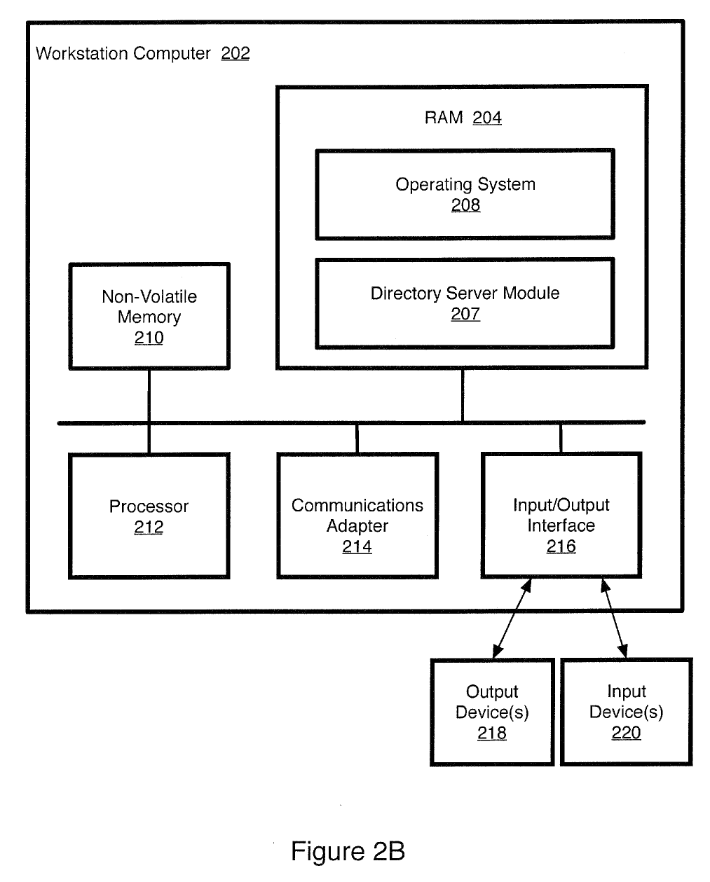

Embodiments of the presently disclosed invention are implemented to some extent as software modules installed and running on computers. Each of the directory servers 102, 104, 106, 108; the augmentation server 120; and the workstation 130 is typically implemented as a computer. FIG. 2A sets forth a block diagram of an exemplary server computer (hereinafter, “server”) 201. FIG. 2B sets forth a block diagram of an exemplary workstation computer (hereinafter, “workstation”) 202. Both computers 201, 202 include at least one computer processor 212 as well a computer memory, including both volatile random access memory (“RAM”) 202 and some form or forms of non-volatile computer memory 204 such as a hard disk drive, an optical disk drive, or an electrically erasable programmable read-only memory space (also known as ‘EEPROM’ or ‘Flash’ memory). The computer memory is connected through a system bus 210 to the processor 212 and to other system components. Thus the software modules are program instructions stored in computer memory.

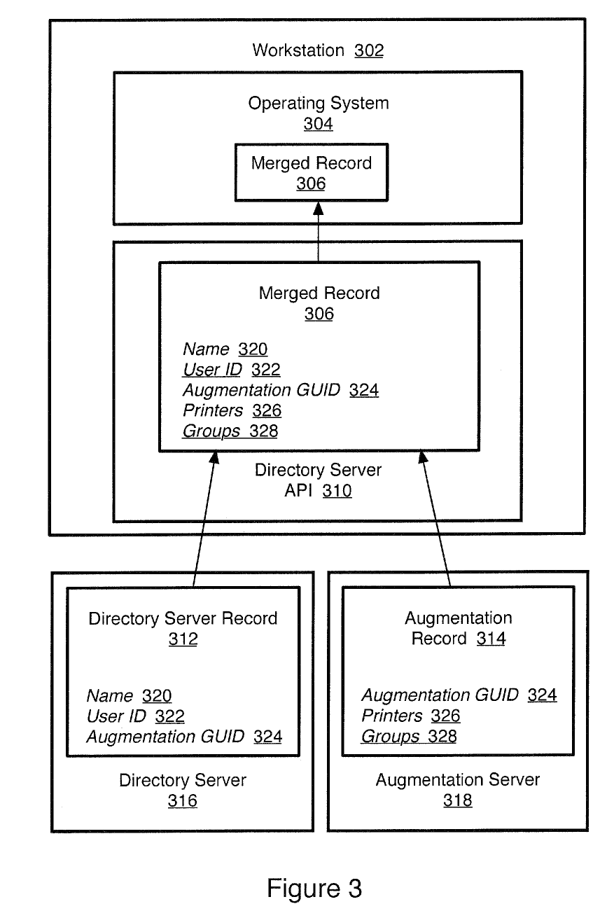

An operating system 208 is also stored in computer memory. Also stored in computer memory is a directory server module 206, 207. The directory server module functionality is different between servers and workstations, as the module 206 on servers stores global user information and communicates with similar modules in other servers as required while the module 207 in the workstations only gathers information for the local user and queries the modules on the servers. For example, the module 207 on the workstation 130 includes a directory server API (310, FIG. 3). The directory server API 310 includes computer program instructions for merging records from the directory servers 102, 104, 106, 108 with records from an augmentation server 120.

Workstation 202 also includes one or more input/output interface adapters 216. Input/output interface adapters 216 may implement user-oriented input/output through software drivers and computer hardware for controlling output to output devices 220 such as computer display screens, as well as user input from input devices 218 such as keyboards and mice.

Workstation 202 also includes a communications adapter 214 for implementing data communications with the directory servers 102, 104, 106, 108 and the augmentation server 120. Communications adapter 214 implements the hardware level of data communications through which one computer sends data communications to another computer through a network. Server 201 includes a similar communications adapter 215.

FIG. 3 is a data flow diagram illustrating records from a directory server 316 and an augmentation server 318 being merged for the use of a workstation 302. Workstation 302 may require access to the records to determine a user's authorization to use the workstation or specific applications or to access particular files. Workstation 302 may also determine user settings from records, such as the peripheral devices available to a user. As described above, often this information may be stored within more than one server. Directory server 316 stores personnel information, while augmentation server 318 stores only data augmenting the information stored in the directory server 316, for example, specific managed computer information. In other implementations, the records of the augmentation server may also contain data duplicative of the data in records in the directory server 316. Only the augmentation data is merged in such implementations.

Upon creation, the augmentation data for a particular user is stored on the augmentation server 318 in an augmentation server record. In one embodiment, when the augmentation server record is created, it is linked to a corresponding unique directory server record of the same user by a globally unique identifier value stored in an “augmentation globally unique identifier (‘GUID’)” field 324 in both the augmentation server record and the directory server record. Thus, in such implementations it is possible to determine if a particular directory server record may be augmented with a particular augmentation record by determining if the values stored in their respective augmentation GUID fields are identical. In other embodiments, an augmentation GUID may be assigned to an existing record in order to classify the record as an augmentation record and link it to a specific primary record. In some implementations, the globally unique identifier value is preferably a unique 128 bit value.

For example, directory server 316 contains a directory server record 312 including attributes of type “name” 320, “user ID” 322, and “augmentation globally unique identifier (‘GUID’)” 324. Each attribute has a corresponding value. For example, the attribute of type “name” may have the value “Joe Smith” and the attribute of type “user ID” may have a randomly assigned, unique numerical value with a required number of digits.

Augmentation server 318 contains an augmentation server record 314 specifically created to correspond with the directory server record 312. Augmentation record 314 includes attributes of type “augmentation GUID” 324, “printers” 326, and “groups” 328. The attribute values of the printers attribute 326 and the groups attribute 328 indicate which printers and groups, respectively, the user “Joe Smith” associated with the records is allowed to use. The GUID is generated when the augmentation server record 314 is created, as described above. The value of the augmentation GUID attribute is identical to that of the augmentation GUID attribute of directory server record 312, to ensure that the correct augmentation record is merged with each directory server record.

The directory server API 310 merges the personnel data from directory server record 312 with the managed computer login data from augmentation record 314 by determining that the directory server record 312 has a corresponding augmentation record 314 and searching for the augmentation record 314. Upon finding the unique augmentation record 314 with the matching augmentation GUID 324, directory server API 310 extracts only the non-duplicative attributes from the augmentation record 314, and combines them with the primary attributes of the directory server record 312 to form the merged record 306. The directory server API 310 may initiate retrieval of the record data from the directory server 316 and the augmentation server 318, or it may access copies of the data local to the workstation 302. In some instances, a priority list of distinct directory servers may be maintained so that record searches may be made over these directory servers for directory data.

For example, merged record 306 includes attributes of type “name” 320, “user ID” 322, “augmentation globally unique identifier (‘GUID’)” 324, “printers” 326, and “groups” 328. Each of the attributes has an attribute value identical to that of the corresponding attribute from the component records. When a client of the directory server API 310, such as the operating system 304, requests a record with a particular attribute value from the directory server API 310, the directory server API 310 returns the merged record 306. Thus, the operation of merging the records from the two servers is transparent to the client.

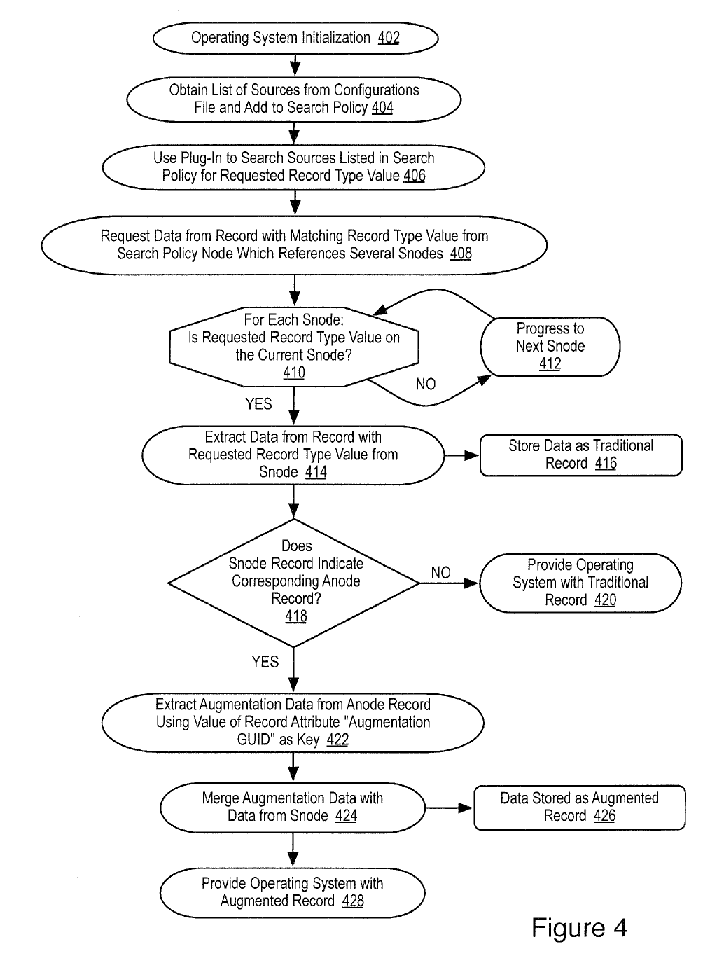

FIG. 4 is a flow chart illustrating a method for constructing a local record composed of data from directory server records and augmenting data from augmentation records. The local record may be constructed upon an initial user login, or the record may be constructed from locally stored values of a record type at boot time after initializing the operating system. For example, after operating system initialization the workstation may construct a record for each value of the record identifier “user,” such as “John Smith” or “Jane Jones.”

The method of FIG. 4 begins with initializing the operating system (block 402). Next, the directory server API consults a local configurations file for information pertaining to priority directory and augmentation servers (block 404). The priority directory and augmentation servers are then added to a search policy file containing a list of sources to consult (block 404). The directory server API uses a plug-in allowing connections to diverse directory servers.

The directory server API uses the plug-in to search across the set of servers listed in the search policy and identify directory server records with a record type value matching the desired record type value (in this case, a record containing the attribute type of “user” having a value of “John Smith”) from a search policy node (block 406). The search policy node references several snodes, which are nodes on the search policy pointing to each directory server 102 included in the search policy (block 408). For each snode, the directory server API 310 determines if the requested record type value is in a directory server record on that snode (block 410). If not, then the directory server API 310 repeats the operation for the next snode (block 412). If the record type value is in a directory server record on the snode, the directory server API 310 extracts data from the record on the snode (block 414), and stores data as a traditional record (block 416).

The next step includes identifying from the extracted snode record data whether or not the “augmentation GUID” record type is contained in the record (block 418). If the “augmentation GUID” record type is not found, the data remains a traditional record, which is then made available to the operating system (block 420). If the “augmentation GUID” record type is found, indicating the existence of an anode record corresponding to the snode record, the directory server API queries the search policy node for the augmentation record containing the augmentation GUID value identical to the augmentation GUID value from the snode record. The search policy node references several anodes, which are nodes on the search policy pointing to an augmentation server 102. When the augmentation record is found, the directory server API 310 extracts augmentation data from the anode record (block 422). Accurately linking the augmentation record to the directory server record is insured by finding the unique augmentation record with an augmentation GUID identical to that of the directory server record. The directory server API 310 then merges the augmentation data with data from the directory server record on the snode (block 424), and stores the data as an augmented record (block 426), which is then made available to the operating system (block 428).

It should be understood that the inventive concepts disclosed herein are capable of many modifications. Such modifications may include modifications in the type of record attributes and their uses, the storage of a local copy of records, and the implementation of a search policy. To the extent such modifications fall within the scope of the appended claims and their equivalents, they are intended to be covered by this patent.

What is claimed is:

1. A method for automated record merging from multiple directory servers, the method comprising:
extracting primary record data from a first record from a first directory server;
identifying, for said first record, a corresponding second record from a second directory server, said second record containing augmenting record data that augments said primary record data on said first directory server;
extracting said augmenting record data from said second record; and
storing said primary record data from said first record and said augmenting record data from said second record in an augmented record.

2. The method of claim 1 wherein said second record contains duplicative record data in addition to said augmenting record data.

3. The method of claim 2 further comprising extracting non-duplicative data as said augmenting record data.

4. The method of claim 1 wherein said second record and said first record uniquely correspond.

5. The method of claim 1 wherein
said first record and said second record each contain an identical globally unique identifier value;
extracting said primary record data from said first record from said first directory server comprises extracting said globally unique identifier value; and
identifying said second record from said second directory server containing augmenting record data that augments said primary record data from said first directory server comprises searching said second directory server for a record containing said identical globally unique identifier value.

6. The method of claim 1 wherein said first record includes a record identifier, the method further comprising providing said augmented record to an operating system when said operating system requests a record with said record identifier.

7. The method of claim 1 wherein specific managed computer login information is stored in said second record.

8. A computer program product for automated record merging from multiple directory servers, the computer program product embodied on a computer-readable medium, the computer program product comprising:
computer program instructions for extracting primary record data from a first record from a first directory server;
computer program instructions for identifying, for said first record, a corresponding second record from a second directory server containing augmenting record data that augments said primary record data from said first directory server;
computer program instructions for extracting said augmenting record data from said second record; and
computer program instructions for storing said primary record data from said first record and said augmenting record data from said second record in an augmented record.

9. The computer program product of claim 8 wherein said second record contains duplicative record data in addition to said augmenting record data.

10. The computer program product of claim 9 comprising computer program instructions for extracting non-duplicative data from said second record as said augmenting record data.

11. The computer program product of claim 8 wherein said second record and said first record uniquely correspond.

12. The computer program product of claim 8 wherein
said first record and said second record each contain an identical globally unique identifier value;
computer program instructions for extracting said primary record data from said first record from said first directory server comprise computer program instructions for extracting said globally unique identifier value; and
computer program instructions for identifying, for said first record, said corresponding second record from said second directory server containing said augmenting record data comprise computer program instructions for searching said second directory server for a record containing said identical globally unique identifier value.

13. The computer program product of claim 8 wherein said first record includes a record identifier, the computer program product further comprising computer program instructions for providing said augmented record to an operating system when said operating system requests a record with said record identifier.

14. The computer program product of claim 8 wherein specific managed computer login information is stored in said second record.

15. A system for automated record attribute value merging from multiple directory servers, the system comprising:
a processor;
a computer memory operatively coupled to said processor; and
a communications adapter operatively coupled to said processor and said computer memory, said communications adaptor for connecting the system through a network to at least one first directory server storing a first record containing primary record data and at least one second directory server storing a second record containing augmenting record data that augments said primary record data;
wherein the computer memory has disposed within it computer program instructions capable of:
extracting primary record data from said first record from said first directory server;
identifying, for said first record, said corresponding second record from said second directory server;
extracting said augmenting record data from said second record; and
storing said primary record data from said first record and said augmenting record data from said second record in an augmented record.

16. The system of claim 15 wherein the computer memory has disposed within it computer program instructions capable of extracting said augmenting record data from said second record having both augmenting record data and duplicative record data contained therein.

17. The system of claim 15 wherein:
said first record and said second record each contain an identical globally unique identifier value;
said computer program instructions for extracting record data from said first record from said first directory server comprise computer program instructions for extracting said globally unique identifier; and
said computer program instructions capable of identifying said corresponding second record from said second directory server having record data that augments record data from said first directory server comprise computer program instructions capable of identifying a record on said second directory server having said globally unique identifier.

18. The system of claim 15 wherein said computer memory has disposed within it computer program instructions for storing said first record and said second record in said computer memory; and
wherein said computer program instructions for identifying, for said first record, said corresponding second record from said second directory server includes identifying said corresponding second record in said computer memory.
